(19) United States
(12) Patent Application Publication
(10) Pub. No.: US 2017/0178383 A1
(43) Pub. Date: Jun. 22, 2017

(54) APPARATUS AND METHOD FOR PRODUCING DISPLAY MATERIAL

(71) Applicant: BEIJING KNET EQXIU TECHNOLOGY CO., LTD., BEIJING (CN)

(72) Inventors: XU LIU, BEIJING (CN); WEIMING ZHU, BEIJING (CN); JIN HUANG, BEIJING (CN); WEI MAO, BEIJING (CN); DIANSHENG LU, BEIJING (CN); QING LI, BEIJING (CN); JINGUO ZHU, BEIJING (CN); YI TANG, BEIJING (CN)

(21) Appl. No.: 15/149,059

(22) Filed: May 6, 2016

(30) Foreign Application Priority Data
Dec. 21, 2015 (CN) 201510967547.3

(51) Int. Cl. G06T 13/80; G06Q 30/02; G06F 3/0484

(52) U.S. Cl. CPC G06T 13/80; G06F 3/0484; G06Q 30/0276

(57) ABSTRACT

The present invention provides an apparatus and a method for producing a display material. The apparatus for producing the display material includes a rendering module and a producing module, where the rendering module renders a display material element, and then the producing module produces a display material according to the display material element rendered by the rendering module. Rendering of the display material is completed through a simple operation, thus production complexity of the display material is reduced, and meanwhile production cost of the display material is reduced.

### CROSS-REFERENCE TO RELATED APPLICATIONS

This application claims priority to Chinese Patent Application No. 201510967547.3, filed on Dec. 21, 2015, entitled “Apparatus and Method for Producing Display Material”, which is hereby incorporated by reference in its entirety.

### TECHNICAL FIELD

The present invention relates to advertizing technologies and, in particular, to an apparatus and a method for producing a display material.

### BACKGROUND

With rapid development of mobile internet technologies, more and more enterprises perform promotion via internet to enhance product publicity, and a vivid display material will bring excellent publicity effects.

Generally, during a process where a large enterprise is performing promotion, an exquisite display material is produced by a professional team, and vividness of an advertisement is enhanced by updating the display material, for instance, adding an animation effect, a trigger interaction function and so on to the display material. Particularly, the display material is content presented by the advertisement, and types thereof include texts, pictures, animations, etc.

However, during a production process of the above display material, logical structure and timeline design is very complex, thus professionals are required to complete it. Production complexity and cost of the display material are high.

### SUMMARY

The present invention provides an apparatus and a method for producing a display material, and rendering of the display material is completed through a simple operation, thus production complexity of the display material is reduced, and meanwhile production cost of the display material is reduced.

In a first aspect, an embodiment of the present invention provides an apparatus for producing a display material, including:

a rendering module, configured to render a display material element; and

a producing module, configured to produce a display material according to the display material element rendered by the rendering module.

Alternatively, the rendering module includes:

an animation adding unit, configured to add an animation function to the display material element.

Alternatively, the animation adding unit includes:

an animation type selecting subunit, configured to select a first animation type for the display material element; and

an animation setting subunit, configured to set the first animation type.

Alternatively, the animation type selecting subunit is also configured to select a second animation type for the display material element after the animation setting subunit sets the first animation type; and

the animation setting subunit is also configured to set the second animation type.

Alternatively, the rendering module includes:

a trigger interaction unit, configured to add a trigger interaction function to the display material element.

Alternatively, the trigger interaction unit includes:

a trigger type selecting subunit, configured to select a first trigger mode for the display material element; and

a trigger interaction setting subunit, configured to set the first trigger mode.

Alternatively, the trigger type selecting subunit is also configured to select a second trigger mode for the display material element after the trigger interaction setting subunit sets the first trigger mode; and

the trigger interaction setting subunit is configured to set the second trigger mode.

In a second aspect, an embodiment of the present invention provides a method for producing a display material, including:

rendering a display material element; and

producing a display material according to the rendered display material element.

Alternatively, the rendering the display material element includes:

adding an animation function to the display material element.

Alternatively, the adding the animation function to the display material element includes:

selecting a first animation type for the display material element; and

setting the first animation type.

Alternatively, after setting the first animation type, the method further includes:

selecting a second animation type for the display material element; and

setting the second animation type.

Alternatively, the rendering the display material element includes:

adding a trigger interaction function to the display material element.

Alternatively, the adding the trigger interaction function to the display material element includes:

selecting a first trigger mode for the display material element; and

setting the first trigger mode.

Alternatively, after setting the first trigger mode, the method further includes:

selecting a second trigger mode for the display material element; and

setting the second trigger mode.

Embodiments of the present invention provide an apparatus and a method for producing a display material, where the apparatus for producing the display material includes a rendering module and a producing module, the rendering module renders a display material element, and then the producing module produces a display material according to the display material element rendered by the rendering module. Rendering of the display material is completed through a simple operation, thus production complexity of the display material is reduced, and meanwhile production cost of the display material is reduced.

### BRIEF DESCRIPTION OF DRAWINGS

FIG. 1 is a schematic structural diagram of an apparatus for producing a display material according to an embodiment of the present invention;

FIG. 2 is a schematic structural diagram of an apparatus for producing a display material according to another embodiment of the present invention;

FIG. 3 is a flowchart of a method for producing a display material according to an embodiment of the present invention.

### DESCRIPTION OF EMBODIMENTS

In order to make objectives, technical solutions and advantages of embodiments of the present invention clearer, the technical solutions in the embodiments of the present invention will be described hereunder clearly and comprehensively with reference to accompanying drawings in the embodiments of the present invention. Obviously, the described embodiments are only a part of embodiments of the present invention, rather than all embodiments of the present invention. All other embodiments obtained by persons skilled in the art based on the embodiments of the present invention herein without any creative effort shall fall into the protection scope of the present invention.

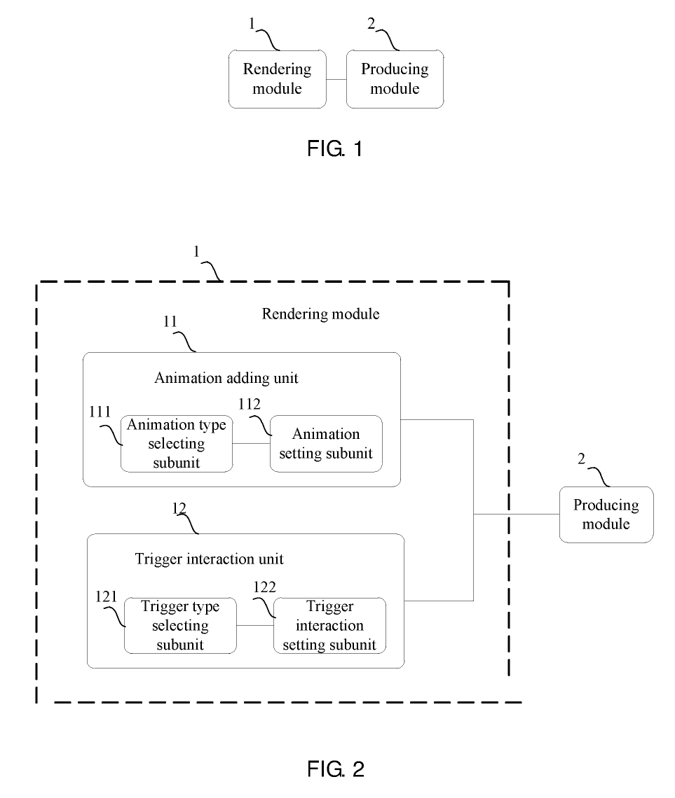

FIG. 1 is a schematic structural diagram of an apparatus for producing a display material according to an embodiment of the present invention. As shown in FIG. 1, the apparatus for producing the display material according to the embodiment of the present invention includes:

a rendering module 1, configured to render a display material element; and

a producing module 2, configured to produce a display material according to the display material element rendered by the rendering module 1.

The apparatus for producing the display material according to the embodiment of the present invention can be operated on various user equipments (User Equipment, UE), for instance, be operated on a desktop computer or a mobile phone. For instance, a user may log in to the apparatus for producing the display material on a computer desktop via an account or the like, and may also log in on a user equipment. The computer is used to produce a display material and the like, and the user equipment is used to view access to the display material and the like at any time any where.

Specifically, in the apparatus for producing the display material, the rendering module 1 is configured to render a display material element in the display material, such as adding an animation function, adding a trigger interaction function, etc. During the rending, for an element in the display material, either the animation function or the trigger interaction function may be added only, or, both the animation function and the trigger interaction function are added. The display material element is, for instance, a character, a show font, an image, a form, etc. After the display material element is rendered, the producing module 2 produces the display material according to the display material element rendered by the rendering module 1.

According to the apparatus for producing the display material provided in the embodiment of the present invention, the rendering module renders the display material element, and then the producing module produces the display material according to the display material element rendered by the rendering module. Rendering of the display material is completed through a simple operation, thus production complexity of the display material is reduced, and meanwhile production cost of the display material is reduced.

FIG. 2 is a schematic structural diagram of an apparatus for producing a display material according to another embodiment of the present invention. As shown in FIG. 2, in the apparatus for producing the display material according to this embodiment, the rendering module 1 includes: an animation adding unit 11, configured to add an animation function to the display material element. Specifically, the animation adding unit 11 includes: an animation type selecting subunit 111, configured to select a first animation type for the display material element; and an animation setting subunit 112, configured to set the first animation type.

In the embodiment of the present invention, the animation type includes: an entering animation, an emphasizing animation, an exiting animation, etc. Each animation type further includes varieties of forms, for instance, a type of the entering animation includes forms such as rotation entering, pop in; a type of the emphasizing animation includes forms such as rotation emphasizing, swing emphasizing, scrolling emphasizing; a type of the exit animation includes forms such as gradual fading, and the like. Basic settings for an animation include settings of animation duration, animation frequency, animation delay time and the like.

Specifically, when an animation effect is added to the display material element, a display material element which requires addition of an animation function is selected from content of the display material, the display material element is, for instance, a character, a show font, an image, a form, etc. Then, a first animation type is selected for the display material element, and the first animation type is, for instance, one of the animation types described above; after the first animation type is selected, basic setting is conducted for the first animation type. For instance, the first animation type is an emphasizing animation type, and its form is swing emphasizing, when basic setting is conducted for the first animation type, duration of the swing and a frequency of the swing of the display material element are set.

In the embodiment of the present invention, an animation sequence may also be added to the display material, that is, the animation type selecting subunit 111 is also configured to select a second animation type for the display material element after the animation setting subunit 112 sets the first animation type; and the animation setting subunit 112 is also configured to set the second animation type.

Specifically, an animation sequence design may be conducted for a display material element, for instance, a multi-animation design is conducted for an image, an animation sequence of various combinations of entering, emphasizing, exiting and so on may be designed, moreover, settings of time, delay and frequency are performed for each animation, thereby achieving an effect of consecutive presentation of multiple animations. During this process, firstly, a first animation type is selected for the display material element, and the first animation type is designed; then, a second animation type is selected for the display material element, and the second animation type is designed; a third animation type is selected for the display material element sequentially, and the third animation type is designed . . . With the help of a simple linear operation, a user can achieve a consecutive multi-form animation design rapidly, which makes the display material worth-watching.

Reference may be made to FIG. 2 again, alternatively, in an embodiment of the present invention, the rendering module 1 includes: a trigger interaction unit 12, configured to add a trigger interaction function to the display material element. Specifically, the trigger interaction unit 12 includes: a trigger type selecting subunit 121, configured to select a first trigger mode for the display material element; and a trigger interaction setting subunit 122, configured to set the first trigger mode.

In the embodiment of the present invention, the trigger type is, for instance, shake, click, etc., where the click takes advantage of characteristics of a touch screen of a terminal, and the shake takes advantage of characteristics of a gyroscope of the terminal.

The display material elements which require addition of a trigger interaction function are equivalent to “touch” elements, the click, the shake and the like are conducted to these “touch” elements, and obtained results are equivalent to “initiate” elements. Thus, during the production of the display material, after a trigger type is selected for a display material element which requires addition of a trigger interaction function, the trigger type requires to be set, that is, “initiate” elements corresponding to “touch” elements are set. The “initiate” elements may be elements of a display material edit zone of the apparatus for producing the display material, and may also be newly added elements.

Specifically, when an animation effect is added to the display material element, a display material element which requires addition of an animation function is selected from content of the display material, the display material element is, for instance, a character, a show font, an image, a form, etc. Then, a first trigger type is selected for the display material element, such as click, shake, etc.; after the first trigger type is selected, basic setting is conducted for the first trigger type. For instance, the display material element which requires addition of a trigger interaction function is a display material element A, the first trigger type is the click, and setting for the first trigger type is to show a display material element B (that is, the “initiate” element is the display material element B), then, after the display material element A is clicked, the display material element B shows up. Moreover, setting for the trigger type may also be hiding of an “initiate” element and the like, the “initiate” element may be a single display material element, and may also be a group of display material elements. For instance, when the setting for the trigger type is to click the display material element, one “initiate” element is shown, when there are a plurality of “initiate” elements, one of the plurality of “initiate” elements is shown randomly at the time when the display material element is clicked.

In the embodiment of the present invention, a consecutive trigger interaction may also be added to the display material, that is, the trigger type selecting subunit 121 is also configured to select a second trigger mode for the display material element after the trigger interaction setting subunit sets the first trigger mode; and the trigger interaction setting subunit 122 is configured to set the second trigger mode.

Specifically, a consecutive trigger interaction design may be conducted for a display material element, for instance, a consecutive trigger interaction design is conducted for a piece of text, and meanwhile trigger interaction such as click and shake are set, and “initiate” elements of different trigger types are set, thereby achieving an effect of consecutive trigger interaction. During this process, firstly, a first trigger type is selected for the display material element, and the first trigger type is designed; then, a second trigger type is selected for the display material element, and the second trigger type is designed; a third trigger type is selected for the display material element sequentially, and the third animation type is designed . . . Likewise, with the help of a simple linear operation, a user can achieve a display material design of multiple trigger interaction, which makes the display material worth-watching.

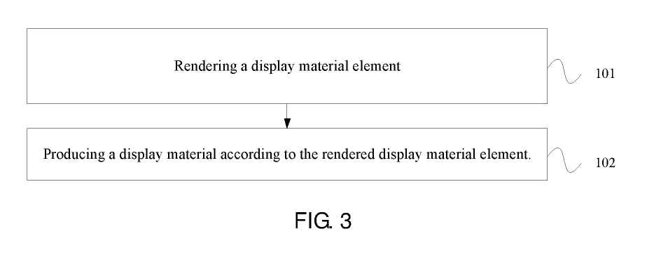

Furthermore, based on the apparatus for producing the display material as described above, the present invention also provides a method for producing a display material. Specifically, reference may be made to FIG. 3. FIG. 3 is a flowchart of a method for producing a display material according to an embodiment of the present invention. The method for producing the display material provided in this embodiment is a method embodiment corresponding to the embodiment of FIG. 1 of the present invention, thus a specific implementation process will not be repeated herein. Specifically, the method for producing the display material provided in this embodiment includes:

101, rendering a display material element.

102, producing a display material according to the rendered display material element.

According to the method for producing the display material according to the embodiment of the present invention, a display material element is rendered, and then a display material is produced according to the rendered display material element rendered. Rendering of the display material is completed through a simple operation, thus production complexity of the display material is reduced, and meanwhile production cost of the display material is reduced.

Alternatively, in an embodiment of the present invention, the rendering the display material element includes: adding an animation function to the display material element.

Further, alternatively, the adding the animation function to the display material element includes:

selecting a first animation type for the display material element; and

setting the first animation type.

Further, alternatively, after setting the first animation type, the method further includes:

selecting a second animation type for the display material element; and

setting the second animation type.

Alternatively, in an embodiment of the present invention, the rendering the display material element includes:

adding a trigger interaction function to the display material element.

Further, alternatively, the adding the trigger interaction function to the display material element includes:

selecting a first trigger mode for the display material element; and

setting the first trigger mode.

Further, alternatively, after setting the first trigger mode, the method further includes:

selecting a second trigger mode for the display material element; and

setting the second trigger mode.

Persons of ordinary skill in the art may understand that, all or a part of steps of the foregoing method embodiments may be implemented by a program instructing relevant hardware. The foregoing program may be stored in a computer readable storage medium. When the program runs, the steps of the foregoing method embodiments are performed. The foregoing storage medium includes various mediums capable of storing program codes, such as a ROM, a RAM, a magnetic disk, or an optical disc.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments, or make equivalent replacements to some or all technical features therein; however, these modifications or replacements do not make the essence of corresponding technical solutions depart from the scope of the technical solutions in the embodiments of the present invention.

What is claimed is:

1. An apparatus for producing a display material, comprising:
a rendering module, configured to render a display material element; and
a producing module, configured to produce a display material according to the display material element rendered by the rendering module.

2. The apparatus according to claim 1, wherein, the rendering module comprises:
an animation adding unit, configured to add an animation function to the display material element.

3. The apparatus according to claim 2, wherein, the animation adding unit comprises:
an animation type selecting subunit, configured to select a first animation type for the display material element; and
an animation setting subunit, configured to set the first animation type.

4. The apparatus according to claim 3, wherein,
the animation type selecting subunit is also configured to select a second animation type for the display material element after the animation setting subunit sets the first animation type; and
the animation setting subunit is also configured to set the second animation type.

5. The apparatus according to claim 1, wherein, the rendering module comprises:
a trigger interaction unit, configured to add a trigger interaction function to the display material element.

6. The apparatus according to claim 5, wherein, the trigger interaction unit comprises:
a trigger type selecting subunit, configured to select a first trigger mode for the display material element; and
a trigger interaction setting subunit, configured to set the first trigger mode.

7. The apparatus according to claim 6, wherein,
the trigger type selecting subunit is also configured to select a second trigger mode for the display material element after the trigger interaction setting subunit sets the first trigger mode; and
the trigger interaction setting subunit is configured to set the second trigger mode.

8. A method for producing a display material, comprising:
rendering a display material element; and
producing a display material according to the rendered display material element.

9. The method according to claim 8, wherein, the rendering the display material element comprises:
adding an animation function to the display material element.

10. The method according to claim 9, wherein, the adding the animation function to the display material element comprises:
selecting a first animation type for the display material element; and
setting the first animation type.

11. The method according to claim 10, wherein, after setting the first animation type, the method further comprises:
selecting a second animation type for the display material element; and
setting the second animation type.

12. The method according to claim 8, wherein, the rendering the display material element comprises:
adding a trigger interaction function to the display material element.

13. The method according to claim 12, wherein, the adding the trigger interaction function to the display material element comprises:
selecting a first trigger mode for the display material element; and
setting the first trigger mode.

14. The method according to claim 13, wherein, after setting the first trigger mode, the method further comprises:
selecting a second trigger mode for the display material element; and
setting the second trigger mode.
